(19) United States
(12) Patent Application Publication
(10) Pub. No.: US 2009/0171859 A1
(43) Pub. Date: Jul. 2, 2009

(54) METHOD FOR BALANCING THE RISK/REWARD STRUCTURE FOR TRANCHES IN COLLATERALIZED DEBT OBLIGATIONS

(76) Inventor: Thomas C. Priore, Chappaqua, NY (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/400,155

(22) Filed: Mar. 9, 2009

Related U.S. Application Data
(63) Continuation of application No. 11/273,734, filed on Nov. 15, 2005.
(60) Provisional application No. 60/629,473, filed on Nov. 19, 2004.

(51) Int. Cl. G06Q 40/00

(52) U.S. Cl. 705/36 R

(57) ABSTRACT

A structured finance transaction, such as an asset securitization, is disclosed which includes a method for balancing the risk reward structure in the transaction by providing an additional tranch of securities, Class X. The Class X tranch of securities, for example, may be amortizing senior secured securities that are used to reduce the payout risks to senior and subordinate tranches. The principal and interest payments to the note holders of the Class X tranch are paid from interest proceeds received from the asset pool, and the excess spread remaining is reinvested during a specified reinvestment period.

### CROSS REFERENCE TO RELATED APPLICATIONS

This application claims priority to and the benefit of U.S. patent application No. 60/629,473, filed on Nov. 19, 2004, hereby incorporated by reference.

### BACKGROUND OF THE INVENTION

1. Field of the Invention

The present invention relates to a structured finance transaction and more particularly to an asset securitization, which includes a method for balancing the risk reward structure in the transaction by providing an additional tranch of securities, for example, an amortizing security in which principal and interest payments are made from interest proceeds received from the asset pool. In addition to the new tranch, excess spread is reinvested during a reinvestment period in order to reduce the payout risks to senior and subordinate tranches.

2. Description of the Prior Art

Securitization is a structured finance transaction whereby various assets, such as, interests in various receivables, fixed income securities, loans, mortgages, lease payments or other receivables or financial obligations, such as loans or debt instruments, are packaged and underwritten with asset-backed securities. This process is known to be used to convert such assets into cash. These structured finance transactions are known as collateralized debt obligations (CDO), collateralized loan obligations (CLO) or collateralized bond obligation (CBO) depending on the asset classes being securitized. Examples of such transactions as applied to different classes of assets are disclosed in U.S. Pat. Nos. 6,654,727 and 6,622,129 and US Published Patent Application Publication No. US 2004/0199440 A1. More particularly, U.S. Pat. No. 6,654,727 discloses a method of securitizing a portfolio of at least 30% distressed loans. U.S. Pat. No. 6,622,129 relates to securitizing another type of asset, namely vehicle leases. US Patent Application Publication US 2004/0199440 A1 relates to a system for the sale and lease back of assets held by the US Government to private entities.

The underlying assets in such transactions are used as collateral for securities that are issued to finance the transaction. In particular, various financial institutions, such as commercial banks, finance companies, thrift institutions and the like sell assets, such as loan and debt repayment obligations for cash. These assets are typically sold to a trust that is insulated from the US Bankruptcy Laws, known as a bankruptcy remote entity, or a special purpose vehicle (SPV). The SPV holds the assets and finances the asset purchase by issuing securities to third party investors that are backed by the assets.

Multiple tranches of securities are generally issued to finance the transaction, offering investors various maturity and credit risk characteristics. Tranches may be categorized as senior, subordinate, and equity, according to the degree of credit risk. If there are defaults by the underlying obligor or the collateral otherwise underperforms, scheduled payments are made on a tiered basis. In particular, senior tranches take precedence over those of subordinate tranches, and scheduled payments to subordinate tranches take precedence over those to equity tranches. Senior and subordinate tranches are typically rated, with the former receiving ratings of BBB to AAA and the latter receiving ratings of CCC to BB. The ratings reflect both the credit quality of underlying collateral as well as the amount of protection a given tranch is afforded by tranches that are subordinate to it.

The payments to the SPV by the portfolio of underlying payment obligations supporting the asset backed securities is generally greater than the interest paid on the securities or coupons and the servicing costs of the SPV for the expenses associated with running the SPV and the expected losses on the underlying debt obligations for a given period. This excess is known as the excess spread. The excess spread is normally paid out to the equity holders.

These structured finance transactions can be either static and managed. In a static transaction, the collateral is fixed through the life of the transaction. In such a transaction, the investors can assess the various tranches of the transaction with full knowledge of what the collateral will be. The primary risk investors face with respect to this type of transaction is credit risk.

With a managed transaction, a portfolio manager is appointed to actively manage the collateral of the transaction. The life of a managed deal can be divided into three phases:
Ramp-up (typically for up to about a year), during which the portfolio manager initially acquires the underlying assets using the proceeds from the sales of securities.
Reinvestment (typically for five or more years), during which the portfolio manager actively manages the collateral; reinvesting cash flows as well as buying and selling assets. It should be noted that even in the case of the static deal, some reinvestment will occur over the life of the CDO as various assets reach full maturity and fully pay out
In the final period, collateral matures or is sold. Investors are paid off.

For example, in a traditional CDO 20 (FIG. 1), interest and principal payments are made from the earnings 22, 24 realized on assets 26. Payments are first made to note holders in the senior tranches 28, 30, and then to note holders in subordinate tranches 32, 34. Any remaining interest and principal 36, 38 are then payable to equity holders and/or unsecured note holders 40, 42. The interest payable to equity holders is referred to as “excess spread”.

The traditional CDO differs somewhat from other traditional financial instruments (for example, corporate stocks), in that it provides continuing payment of excess spread to equity holders during the life of the CDO. As a result, the risk/reward position for senior and subordinate tranches relative to equity holders can be somewhat inferior to the risk/reward position for comparable classes of corporate stock and bond holders, and may be perceived by those considering investments in the senior and subordinate tranches as being less desirable. during the life of a CDO. Although some excess spread must none-the-less be maintained in order to provide a cushion for expected losses in the portfolio, there is a need to improve the risk/reward position of the senior and subordinate tranches.

### SUMMARY OF THE INVENTION

The present invention relates to a structured finance transaction, such as an asset securitization, which includes a method for balancing the risk reward structure in the transaction by providing an additional tranch of securities, Class X. The securities in the Class X tranch may be, for example, amortizing senior secured securities that are used to reduce the payout risks to senior and subordinate tranches. The principal and interest payments to the note holders of the Class X tranch are paid by proceeds that traditionally get paid out to equity holders as excess spread. Additionally, remaining excess spread may be reinvested in new collateral during a reinvestment period.

### DESCRIPTION OF THE DRAWING

These and other advantages of the present invention will be readily understood with reference to the following description and attached drawing, wherein:

FIG. 1 is a block diagram illustrating the flow of interest and principal payments over the life of a traditional structured finance transaction, such as a collateral debt obligation (CDO).

FIG. 2 is a block diagram illustrating the flow of payments over the life of a CDO in accordance with the present invention.

FIG. 3 is a flow diagram illustrating the steps for initially modeling and creating a class X tranch and reinvestment of the excess spread to fund payments to the Class X tranch according to the present invention.

### DETAILED DESCRIPTION

The present invention relates to a structured finance transaction, for example, a securitization. In order to balance the risk/reward position of the senior and subordinate tranches relative to the equity holders, the transaction is structured with an additional tranch, referred to herein as “Class X”. Amortized like a mortgage payment, the securities in the Class X tranch are designed to make interest and principal payments such that the principal balance is paid to zero by the end of the payment period. Prior to initial ramp-up of the transaction, a modeling analysis is performed to size the tranch such that it can be funded from the excess spread, while accounting for associated risks such as expected defaults on assets. In addition, the modeling analysis checks to make sure that the added tranch creates no undesired effects with regard to the other tranches (for example, causing a decline in associated bond ratings for the senior tranches). While the addition of the class X note provides an effective means for reducing excess spread payouts available to the unsecured/equity tranches during the life of a transaction, some excess spread must none-the-less be maintained in order to provide a cushion for expected losses in the portfolio. As such, an additional step is provided for the reinvestment of excess spread during at least a portion of the life of the transaction. In particular, the excess spread is reinvested during a selected time period (for example, the first five years of an 8 year life, or approximately ¾ of the life period) in additional assets, thereby providing additional collateralization to the note holders in the senior and subordinate tranches. This additional collateral reduces payout risks to these tranches. In addition, the additional collateral increases the equity available for payout to the equity holders at the end of the life of the transaction.

The principles of the present invention apply to various structured finance transactions, such as collateral debt obligations (CDO), collateral loan obligations (CLO) as well as virtually any asset securitization. For example, the principles of the present invention can be used in conjunction with the securitization of virtually any asset class including interests in various receivables, fixed income securities, loans, mortgages, lease payments or other receivables or financial obligations, and underwriting these assets with asset-backed securities. For example, U.S. Pat. No. 6,654,727 relates to a method of securitizing a portfolio of at least 30% distressed loans. U.S. Pat. No. 6,622,129 relates to securitizing another type of asset, namely vehicle leases. US Patent Application Publication US 2004/0199440 A1 relates to a system for the sale and lease back of assets held by the US Government to private entities.

Asset securitization is also known to be used with real estate assets. For example, US Patent Application No. US 2005/0010517 A1 discloses a method of financing tenant improvements in leased real estate. Real estate securitizations are also known that are partially or fully collateralized by so called net lease assets.

In a typical asset securitization transaction, a trust or other special purpose vehicle (SPV) that is insulated from creditors. The SPV is formed for the sole purpose of purchasing the assets and issuing securities to finance the transaction during a ramp up period as discussed above. During a reinvestment period (typically for five or more years), the portfolio manager actively manages the collateral; reinvesting cash flows as well as buying and selling assets. In the final period, collateral matures or is sold and the note holders are paid off. A detailed description of a known collateral debt obligation (CDO) is described in detail in U.S. Pat. No. 6,654,727, hereby incorporated by reference.

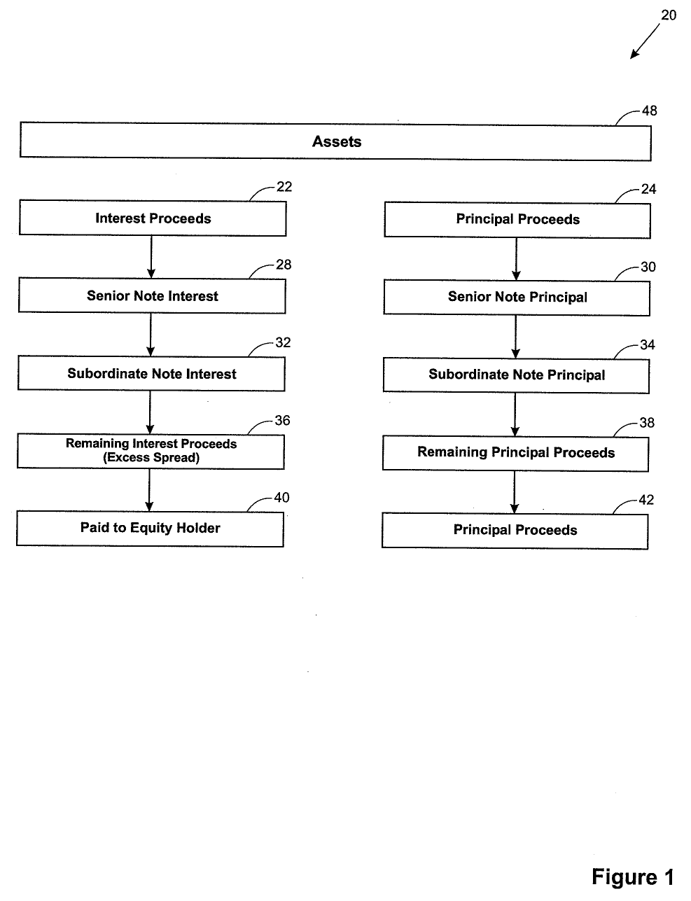

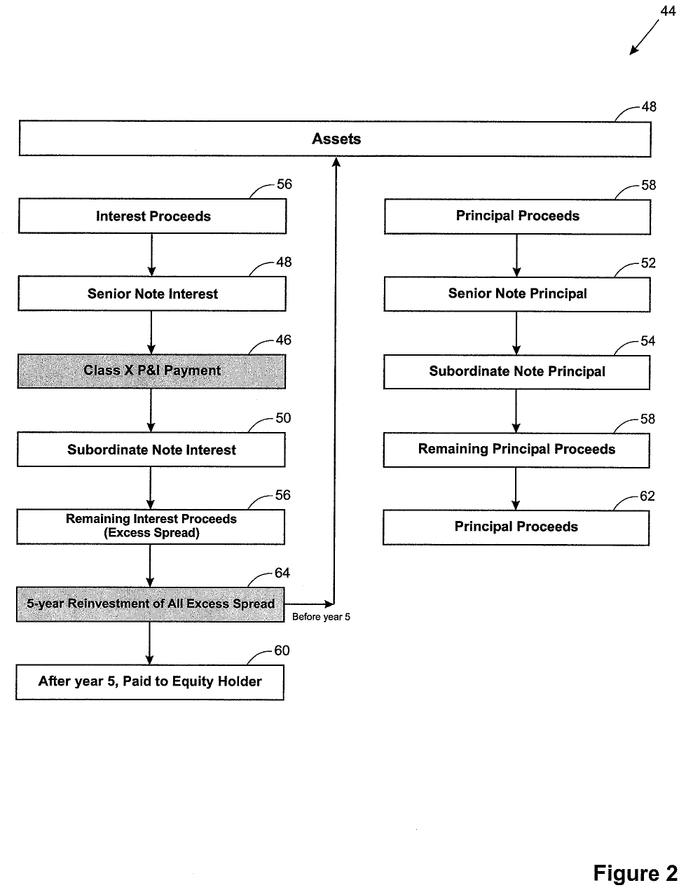

In a accordance with the present invention, the structure of the asset securitization transaction is illustrated in FIG. 2. and generally identified with the reference numeral 44. In accordance with the present invention, an additional tranch of securities, referred to herein as Class X and generally identified with the reference numeral 46 are issued to fund the purchase of the assets 48 during the ramp-up period. The Class X tranch securities are issued in addition to the senior tranch and the subordinate tranch of securities 50. Similar to a traditional asset securitization as discussed above in connection with FIG. 1, interest 48, 50 and principal payments 52, 54 are paid to senior and subordinate note holders from earnings 56, 58 on the assets 48. Any remaining interest and principal 56, 58 is then payable to equity holders and/or unsecured note holders 60. Unlike traditional asset securitizations, the Class X notes are paid their principal and interest from interest proceeds received from the asset pool. As mentioned above, some excess spread must be maintained in order to provide a cushion for expected losses in the portfolio. Thus, in accordance with an important aspect of the invention, the excess spread is reinvested, as indicated in step 64, during at least a portion of the life of the transaction. In particular, the excess spread is reinvested during a selected time period (for example, the first five years of an 8 year life, or approximately ¾ of the life period) in additional assets, thereby providing additional collateralization to the note holders in the senior and subordinate tranches. This additional collateral reduces payout risks to these tranches, thus improving their risk/reward position relative to the equity bond holders.

In accordance with the present invention, the excess spread is re-prioritized and used to:
Align investor risk/reward profiles
Protect liabilities of CDO structure against poor credit performance periods
Reduce overall cost of funding of asset pool

The Class X tranch may comprise fixed rate amortizing bonds or securities which receive a fixed payment as indicated in step 46 (FIG. 2) that is applied to both principal and interest payments. This payment is funded from the interest proceeds 56 in the priority of payments of the transaction and is amortized like a mortgage payment. For example, assuming a $100 payment is made each month to note the interest is paid on balance of the note for the amount of time period owed, then all remaining payment goes to pay down principal. At the end of payment period, principal balance is paid to zero.

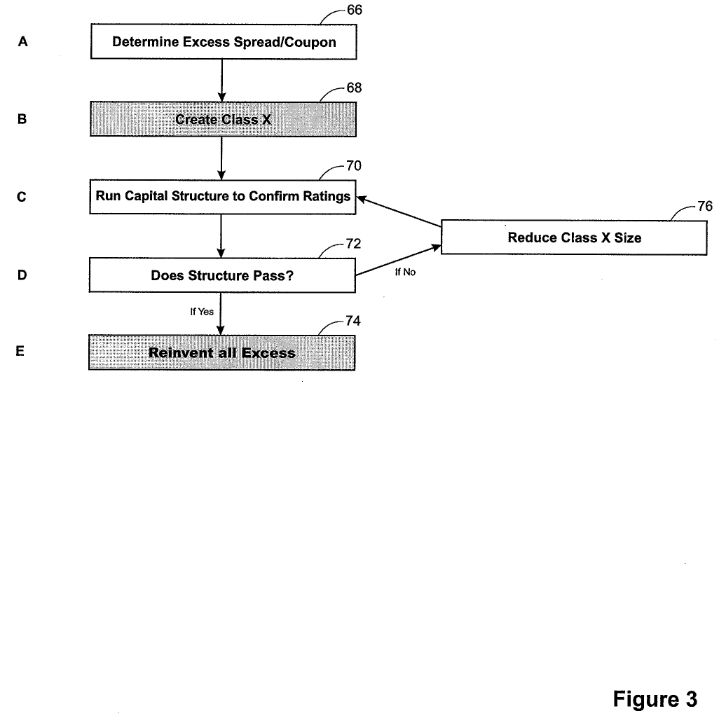

FIG. 3 is a flow diagram illustrating the steps for initially modeling and creating a class X tranch and reinvestment of the excess spread to fund payments to the Class X tranch according to the present invention. Initially, the excess spread is determined in step 66 by analyzing the asset/liability spread. In general, the excess spread is determined by subtracting the principal and interest payments, as indicated in steps 48, 50, 52 and 54 (FIG. 2) and the applicable servicing fees from the gross interest proceeds 56 (FIG. 2). As such, the available excess spread is determined in a conventional manner as the weighted average coupon spread from the assets 48 (FIG. 2) less the projected weighted averaged cost of finds from the liability structure. For example, for an asset spread of 5% minus a liability cost of 3% yields an excess spread of 2%. In other words, the income or interest from the assets 48 (FIG. 2) is determined. Interest and principal payments to the note holders of the senior and subordinate tranches is subtracted from the income. The interest payments are determined as a weighted average. Also subtracted from the income are the transaction fees. The net result is the excess spread.

Referring back to FIG. 3, the size of the class X tranch is determined next in step 68. In particular, it is to be noted that all excess spread cannot be used for payment of class X since to do so would be detrimental to note holders of the tranches following the class X payment. Moreover, there must be enough interest remaining to pay all notes and provide cushion for any expected losses in the portfolio.

1. First, a weighted average rating factor and a weighted average life of assets is used to determine the probability of default of assets, for example, using Moody's historical default table. For example, a weighted average rating factor of 2100 and a 5-year average life corresponds to 20% expected default rate. In general, as used herein the weighted average rating factor may be determined as the sum of all of the products obtained by multiplying the principal balance of each of the underlying debt obligations by its respective Moody's rating factor and dividing the sum by the sum total of the principal balances of all of the underlying debt obligations and rounding up the result to the nearest whole number. As of any measurement date, the weighted average life of assets may be determined by summing all of the products obtained by multiplying the amount of each payment of principal and each commitment reduction with respect to the underlying debt obligations scheduled to be made after the measurement date to the due date of the payment or commitment reduction and dividing the sum by the aggregate principal balance of all of the underlying debt obligations divided by 360.

2. Next, the expected default rate as determined above is multiplied by two (2). The product is then subtracted from 100%. The difference is then multiplied by the excess spread to find a starting point for Class X payment. For example , if the expected default rate is determined to be 20% and the excess spread is determined in step 66 to be 2%, then the cash flow used for payment of the note holders in the Class X tranch is determined to be 1.2% [(100%−40%)*2. %]. Thus, using the above example, 1.2% of the cash flows are used for payment of the note holders of the Class X tranch.

3. An initial size of the Class X tranch is selected using a payment amount and market rate for a similar rated asset. For example, if the Class X is an A2 rated asset which trades in the market at a 4.8% coupon. a 1.2% spread represents a $2.5 M per annum, for example. For a term of 30 quarterly periods, the present value of such an annuity is equal to $16 M.

Next, in step 70 (FIG. 3) capital structures are run for the size of the Class X tranch determined above to determine if the size has negatively affected any other liabilities in the structure. It is important to note that Rating Agency methodology models may not produce the desired ratings for the senior and subordinate tranches of securities in this situation. Thus, in step 72, if the desired ratings are achieved in step 70, then the excess is reinvested in step 74 below. If the ratings are not achieved as determined in step 72, then the size of the Class X tranch is reduced in step 76. The size of the Class X tranch may be reduced by multiplying the cash flow amount determined in step 68, for example, by 90%. If the new cash flow amount for Class X is lower than, for example, 10% of original excess spread amount, then Class X is eliminated from the capital structure the excess spread is reinvested in step 74. Otherwise, the capital structures are run with the reduced size of the Class X tranch to confirm the ratings of the other tranches of securities. Assuming, the ratings of the other tranches are confirmed with the reduced size of the Class X tranch, as determined in step 72, the size of the Class X tranch is finalized and the excess spread is re-invested in step 74.

In step 74, all remaining excess spread as determined in step 66 is reinvested during the reinvestment period, for example, 5 years. By doing so additional collateralization for all note holders is created that in a traditional structure would not be available because all of the excess proceeds are paid out to the equity share holders. In this example, the remaining 0.8% spread is reinvested in additional assets.

Obviously, many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A method for balancing the risk reward structure for a structured finance transaction, the method comprising the steps of:
(a) acquiring a plurality of assets;
(b) funding the acquisition of the assets by selling a plurality of tranches of securities collateralized by the assets;
(c) funding payments to the holders of the securities of said multiple tranches based on the income from said assets;
(d) determining the amount of income remaining after payments to the holders of the securities are made and any servicing fees are paid defining an excess spread; and
(d) creating an additional tranch of securities which receives its interest and principal payments from interest proceeds received from the asset pool;
(e) re-investing said excess spread;
(f) funding said additional tranch based on the proceeds from re-investing said excess spread.

2. The method as recited in claim 1, wherein step (a) comprises acquiring a plurality of debt obligations.

3. The method as recited in claim 1, wherein step (d) comprises creating an additional tranch of securities including amortizing securities.

4. The method as recited in claim 1, wherein step (d) comprises creating an additional tranch of securities including fixed rate securities.

5. The method as recited in claim 1, wherein step (d) includes the step of confirming the ratings of said plurality of tranches after the size of said additional tranch of securities is selected

6. The method as recited in claim 5, wherein step (d) includes the step of adjusting the size of said additional tranch of securities based on the ratings of said plurality of tranches.
